(19) United States
(12) Patent Application Publication
(10) Pub. No.: US 2017/0255220 A1
(43) Pub. Date: Sep. 7, 2017

(54) CRYSTAL-LESS CLOCK THAT IS INVARIANT WITH PROCESS, SUPPLY VOLTAGE, AND TEMPERATURE

(71) Applicant: QUALCOMM Incorporated, San Diego, CA (US)

(72) Inventors: Shyam SIVAKUMAR, Mountain View, CA (US); Kevin WANG, Poway, CA (US)

(21) Appl. No.: 15/271,104

(22) Filed: Sep. 20, 2016

Related U.S. Application Data
(60) Provisional application No. 62/302,734, filed on Mar. 2, 2016.
(60) Provisional application No. 62/370,602, filed on Aug. 3, 2016.
(60) Provisional application No. 62/379,206, filed on Aug. 24, 2016.

(51) Int. Cl. G05F 3/26

(52) U.S. Cl. CPC G05F 3/267

(57) ABSTRACT

A method of generating a bandgap voltage in an electronic circuit includes generating a bandgap current. The method further includes operating the electronic circuit using the bandgap voltage and the bandgap current. The operating can be based on a relationship, such as a ratio of the bandgap voltage to the bandgap current.

### CROSS-REFERENCE TO RELATED APPLICATIONS

The present application claims the benefit of U.S. Provisional Patent Application No. 62/379,206, filed on Aug. 24, 2016, entitled “A CRYSTAL-LESS CLOCK THAT IS INVARIANT WITH PROCESS, SUPPLY VOLTAGE, AND TEMPERATURE,” U.S. Provisional Patent Application No. 62/370,602, filed on Aug. 3, 2016, entitled “A CRYSTAL-LESS CLOCK THAT IS INVARIANT WITH PROCESS, SUPPLY VOLTAGE, AND TEMPERATURE,” and U.S. Provisional Patent Application No. 62/302,734, filed on Mar. 2, 2016, entitled “TEMPERATURE AND SUPPLY INDEPENDENT RC OSCILLATOR,” the disclosures of which are expressly incorporated by reference herein in their entireties.

### BACKGROUND

Technical Field

The present disclosure relates generally to oscillator circuits, and in particular to crystal-less clock circuits that are independent of process, supply voltage, and temperature.

Background

Crystal-less clock sources are desirable in many applications. While a crystal oscillator (XO) may have superior period jitter, it suffers from two limitations. First, the startup time of the XO is typically on the order of milliseconds. Secondly, the amount of electric current to operate a crystal oscillator is typically on the order of milliamps. For example, a commercial 19.2 MHz XO may take up to 50 ms to start up while drawing 2.5 mA of current from a 3V supply.

Conventional crystal-less oscillator designs have various shortcomings. Ring oscillators, for example, generally have inherently high variation over both power supply voltage (V) and temperature (T). Compensating a ring oscillator for voltage and temperature (VT) variations can be difficult. LC-based oscillators can offer inherently high VT independence; however LC oscillators tend to be area intensive and not suited for low frequency applications.

An RC relaxation oscillator has a frequency that is primarily set by the RC product, so it has a naturally high V independence. Further, by realizing capacitor C using MOMCAP technology (which have a temperature coefficient of zero), the remaining source of variation is the temperature dependence of the resistor R. In traditional CMOS RC oscillators, this issue can be addressed in some technologies by building the resistor as a weighted sum of two materials having opposing temperature coefficients; for example, by combining poly and diffusion resistors in a suitable ratio. However, this passive approach has its limitations. Building two such resistive materials may involve additional implants or special processing steps, thereby increasing fabrication costs. Moreover, in some technologies (e.g., Fin Field Effect Transistors (FinFETs)) this approach is not even an option, as only one kind of high resistivity material that is production-worthy is available. Even in technologies that offer two resistors with opposing tempcos, if one (or both) resistors shows large enough process variations, this method does not work well and can result in large variation of the combined tempco.

### SUMMARY

In an aspect of the present disclosure, a method of generating a bandgap voltage in an electronic circuit is presented. The method includes generating a bandgap current. The method further includes operating the electronic circuit using the bandgap voltage and the bandgap current. The operating may be based on a ratio of the bandgap voltage to the bandgap current.

In another aspect of the present disclosure, a circuit is presented. The circuit has a first current generator configured to generate a first current that varies with temperature, as well as a second current generator configured to generate a second current that varies with temperature in opposite relation to the first current. The circuit further includes a voltage generator, connected to the first and second current generators, which has an output for a bandgap voltage based on the first current and the second current. The circuit further includes a current generating circuit connected to the first current generator and the second current generator that has an output for a bandgap current based on the first current and the second current. The circuit also includes a capacitor selectively configurable in a first configuration to receive the bandgap current to charge the capacitor and a second configuration to discharge the capacitor. The circuit further includes a comparator configured to produce a comparator signal based on the reference voltage and a capacitor voltage across the capacitor. The capacitor is configured in the first configuration and the second configuration in response to the comparator signal. The comparator signal varies in time in response to the capacitor being charged and discharged. The comparator signal has a period that is based on the reference voltage across a resistor and the charging current.

In yet another aspect of the present disclosure, a circuit is presented. The circuit includes an RC oscillator having a proportional to absolute temperature (PTAT) core and a complementary to absolute temperature (CTAT) core configured to generate a bandgap voltage and a bandgap current. The RC oscillator is configured to generate a temperature invariant oscillatory signal having a period that is based on the voltage and the current. The circuit further includes a frequency generator and a calibration engine. The calibration engine has an output for a multiplier and is configured to produce the multiplier based on the temperature invariant reference frequency of the RC oscillator and an external reference frequency. The frequency generator is configured to generate an output signal by regulating a frequency of the output signal to the temperature invariant reference frequency of the RC oscillator times the multiplier to produce a temperature invariant output frequency.

In still another aspect of the present disclosure, a circuit includes a first current generator configured to generate a first voltage that varies with temperature. The circuit also has a second voltage generator configured to generate a second voltage that varies with temperature in opposite relation to the first voltage. The circuit further includes a current generating circuit, connected to the first and second current generators, that has an output for a bandgap current based on the first voltage and the second voltage. The circuit also includes a voltage generating circuit connected to the first voltage generator and the second voltage generator that has an output for a bandgap voltage based on the first voltage and the second voltage. The circuit further includes a capacitor selectively configurable in a first configuration to receive the bandgap current to charge the capacitor and a second configuration to discharge the capacitor. The circuit further includes a comparator configured to produce a comparator signal based on the bandgap voltage and a capacitor voltage across the capacitor. The capacitor is configured in the first configuration and the second configuration in response to the comparator signal. The comparator signal varies in time in response to the capacitor being charged and discharged. The comparator signal has a period that is proportional to a ratio of the reference voltage across a resistor and the charging reference current.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 shows a clock source in accordance with some aspects of the present disclosure.

FIG. 1A shows details of calibration engine in accordance with some aspects of the present disclosure.

FIG. 1B illustrates an example of a frequency generator that can be adapted for in a clock source in accordance with the present disclosure.

FIG. 2 is a high level block diagram of a temperature independent circuit for realizing a temperature independent resistance quantity in accordance with the present disclosure.

FIG. 2A shows a high level block diagram of the temperature invariant oscillator (TIO) of FIG. 1 in accordance with the present disclosure.

FIG. 3 shows some details of an exemplary temperature independent oscillator in accordance with the present disclosure.

FIGS. 3A and 3B illustrate different operational states of the temperature independent oscillator shown in FIG. 3.

FIG. 3C shows some illustrative timing charts in accordance with the present disclosure.

FIG. 4 illustrates an exemplary bias for a temperature independent oscillator in accordance with some aspects of the present disclosure.

FIG. 4A illustrates an exemplary bias for a temperature independent oscillator in accordance with aspects of the present disclosure.

FIG. 4B illustrates an exemplary bias for a temperature independent oscillator in accordance with aspects of the present disclosure.

FIG. 5 illustrates examples of voltage-temperature behavior of p-n junctions.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples, alone or in combination with other features described below, and may further include modifications and equivalents of the features and concepts described herein.

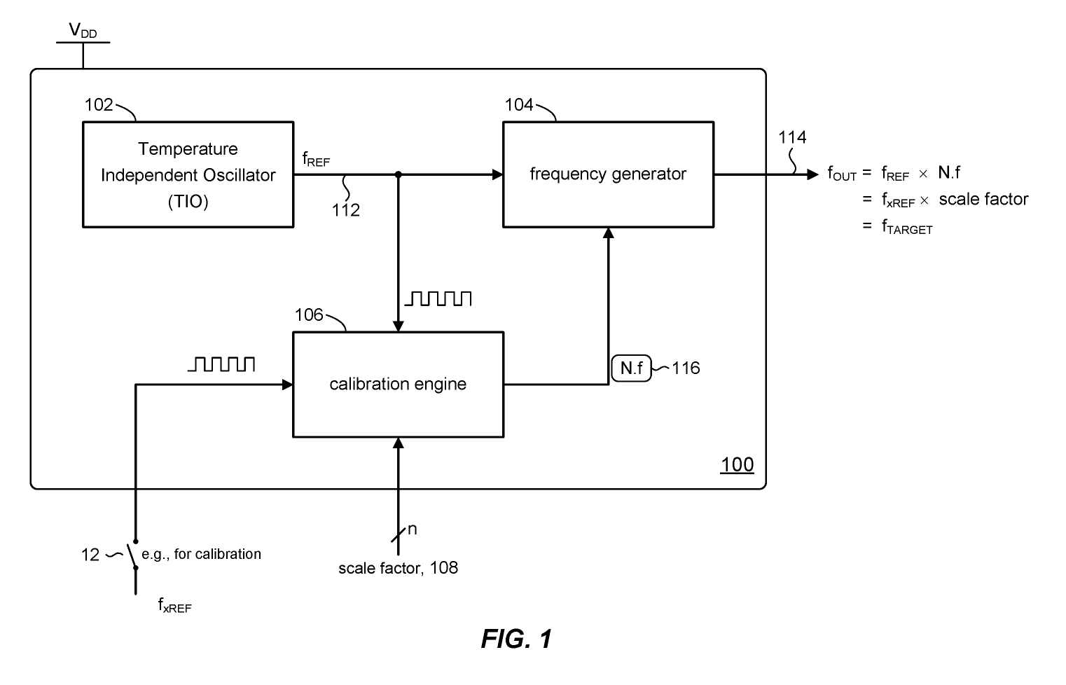

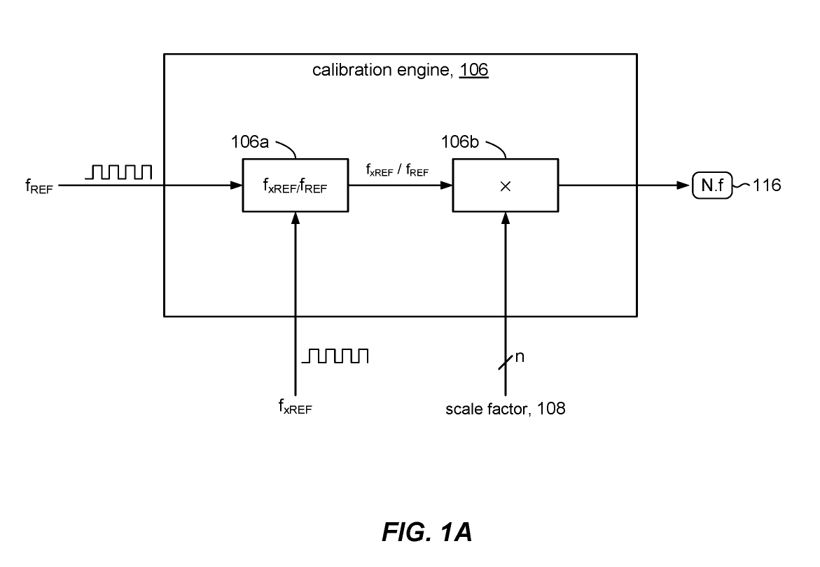

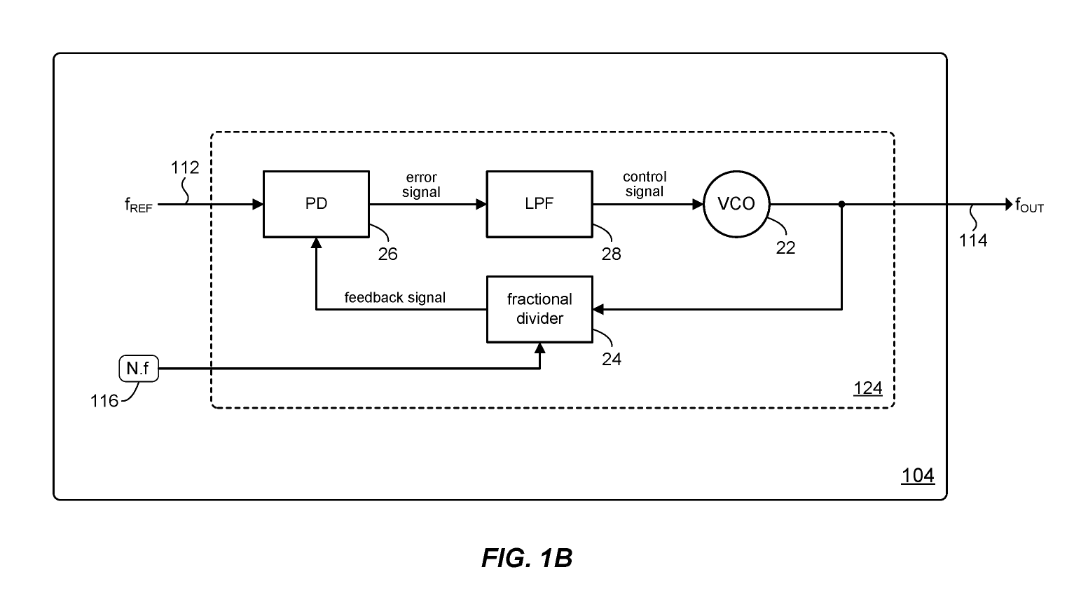

In accordance with the present disclosure, a high performance, high precision clock source can be realized without an externally supplied crystal reference (crystal-less). Referring to FIG. 1, for example, a clock source may be realized as a crystal-less oscillator circuit (“oscillator”) 100. In accordance with the present disclosure, the oscillator 100 may include a temperature invariant (insensitive, independent, etc.) oscillator (TIO) 102 to serve as a reference generator, and a frequency generator 104. The TIO 102 may produce a signal at an output 112. The frequency generator 104 may produce an output signal 114 using the signal at output 112 as a reference frequency f_{REF}.

In some aspects, the reference frequency f_{REF} may be bounded, but otherwise unpredictable; for example, f_{REF} may vary plus or minus some percentage about a mean value. Merely to illustrate this point, suppose the TIO 102 is designed for 19.2 MHz operation. The actual operating frequency may vary (e.g., ±20%) from one instance of the TIO 102 to another. This can arise, for example, due to tolerances in the devices used make the TIO 102. For example, process variations can result in devices having slight variations in operating characteristics. The resulting variations in the fabricated devices can affect the actual value of the reference frequency f_{REF} and hence the output frequency f_{OUT}.

In accordance with aspects of the present disclosure, the oscillator 100 may include a calibration engine 106. The calibration engine 106 may be used to perform a digital frequency locked loop calibration based on the actual value of a given reference frequency f_{REF}. The calibration engine 106 may generate a multiplier 116 that can be provided to the frequency generator 104. The frequency generator 104 may generate an output signal 114 having a frequency f_{OUT} that is a product of the reference frequency f_{REF} and the multiplier 116. In some aspects, the multiplier 116 may be an integer valued multiplier. In other aspects, the multiplier 116 may include a fractional part and the frequency generator 104 may be a frequency synthesizer that operates in fractional mode and multiplies the reference frequency f_{REF} with the fractional multiplier 116.

The calibration engine 106 may include a signal input for the reference frequency f_{REF} and a signal input for an external reference frequency f_{xREF}. The external reference frequency f_{xREF} may be a very stable, very accurate frequency source. In some aspects, for example, the external reference frequency f_{xREF} may be provided from a crystal oscillator. A switch 12 may be provided to switch in or switch out the external reference frequency f_{xREF}. For example, during manufacturing a crystal oscillator having frequency f_{xREF} may be connected to the calibration engine 106 (e.g., switch 12 is CLOSED) for calibration purposes, and subsequently disconnected when calibration is complete (e.g., switch 12 is OPEN). In some aspects, the calibration engine 106 may include an n-bit data input 108 for a scale factor. This scale factor may be a pure integer or a decimal value (e.g., the scale factor can also include a fractional part).

Referring for a moment to FIG. 1A, in some aspects the calibration engine 106 may include a divider module 106a configured to receive the f_{REF} and f_{xREF} signals and produce a value that represents the ratio

$$\frac{{f}_{xref}}{{f}_{ref}} .$$

In some aspects, for example, the divider module 106a may comprise logic (e.g., field programmable gate arrays) configured to compute the ratio

$$\frac{{f}_{xref}}{{f}_{ref}}$$

from the input signals f_{REF} and f_{xREF}; e.g., by counting pulses (or edges) in the f_{REF} and f_{xREF} signals. The calibration engine 106 may include a multiplier module 106b configured to multiply the ratio

$$\frac{{f}_{xref}}{{f}_{ref}}$$

with the n-bit scale factor 108 to produce the multiplier 116, representing the quantity

$$\frac{{f}_{xref}}{{f}_{ref}} \times scale factor .$$

In some aspects, the multiplier module 106b may comprise logic (e.g., field programmable gate arrays) configured to compute the multiplier 116. In other aspects, the calibration engine 106 may comprise a processing component (e.g., central processing unit, digital signal processor, general 10 processor, etc.) configured (e.g., with program code) to compute the multiplier 116, and so on.

Returning to FIG. 1, the output frequency f_{OUT} of frequency generator 104 becomes

$${f}_{ref} \times ( \frac{{f}_{xref}}{{f}_{ref}} \times scale factor ) ,$$

which can be reduced to f_{xref} λscale factor.

Notably, f_{REF}, which is an unpredictable quantity, falls out of the computation. Thus, a target frequency f_{TARGET} may be set by choosing an appropriate value for scale factor 108 for a given frequency f_{xREF} of the external oscillator, independently of f_{REF}. While the external reference frequency f_{xREF} (e.g., a crystal) may provide a stable reference, the scale factor 108 can provide the ability to specify frequencies for output signal 114. Because the scale factor 108 incorporates f_{REF}, which is unpredictable with process but constant over temperature and supply voltage, f_{xREF} can be omitted after a calibration output N·f (where N represents the integer portion, and f represents the fractional portion) is determined by the calibration engine 106. The output N·f (116) is determined by the calibration engine 106. N·f denotes a decimal value where N is the integer portion, and f is the fractional part. For example, if N·f is equal to 5.3, then N is equal to 5 and f is equal to 3. In some aspects, different frequencies for the output signal 114 may be generated during circuit operation by simply changing the scale factor value provided to the scale input 108.

Thus, although the f_{REF} of a given TIO 102 may vary due to process variation, the multiplier 116 can be used to permanently correct for such deviations. To the extent that f_{REF} does not vary with temperature and supply voltage, the calibration can be a one-time procedure. For example, the calibration of TIO 102 using an external crystal oscillator to provide a stable frequency (f_{xREF}) can be done during circuit test at the time of manufacture. After calibration, the external crystal oscillator is no longer used and can be switched out. The calibration can provide a precise output frequency f_{OUT}, and the TIO 102 can operate without the external crystal oscillator (crystal-less operation) and still provide a highly stable reference frequency f_{REF}. It can be appreciated that a TIO 102 in accordance with the present disclosure is robust against aging and hence f_{REF} generally does not vary over time.

The discussion will now turn to a description of the frequency generator 104 in accordance with various aspects of the present disclosure. The frequency generator 104 may use any suitable frequency generator design. Merely to illustrate this point, FIG. 1B for example, shows in some aspects that a frequency generator 104 may be based on a phase locked loop (PLL) 124. The PLL 124 may include a voltage controlled oscillator (VCO) 22 that produces the output signal 114 of oscillator 100. The output frequency of the VCO 22 may be controlled by a VCO control signal provided to the VCO 22. A feedback signal may be produced using a fractional divider 24 to divide the output frequency f_{OUT} by multiplier 116. A phase detector circuit 26 may produce an error signal based on whether the feedback signal leads or lags the reference frequency f_{REF} (e.g., from TIO 102). The error signal may be filtered by a low pass filter 28 to produce the V_{C} control signal, which is used to control VCO 22 to produce the output signal 114.

One of ordinary skill will appreciate that frequency generator 104 may be realized with other designs. In some aspects, for example, the frequency generator 104 may be based on a digital frequency locked loop (DFLL). In some aspects, a DFLL may be more suitable over a PLL because the DFLL can be more compact and thus may be implemented in a reduced silicon area. A DFLL, by virtue of its digital nature, can also generate an output signal 114 having a frequency of arbitrary precision; for example, by designing the DFLL with a sufficient number of bits (resolution). In other aspects, a frequency lock loop (FLL) may be use to implement the frequency generator 104, and so on.

Frequency generators, whether a PLL, DFLL, and so on, typically include low pass filtering as part of its operation to filter high frequency artifacts that may arise during operation of the frequency generator. The filtering provided in frequency generators can relax certain design aspects of the TIO 102. For example, the jitter performance and power supply rejection performance requirements of the TIO 102 can be lowered in order to simplify the design of the TIO 102. The noise that can arise in the TIO 102 due to these lowered requirements can be filtered out by the frequency generator 104. On the other hand, in accordance with the present disclosure, the TIO 102 can provide a temperature invariant reference frequency f_{REF}. This fact can be used to relax constraints in the frequency generator 104 to design for temperature stable operation.

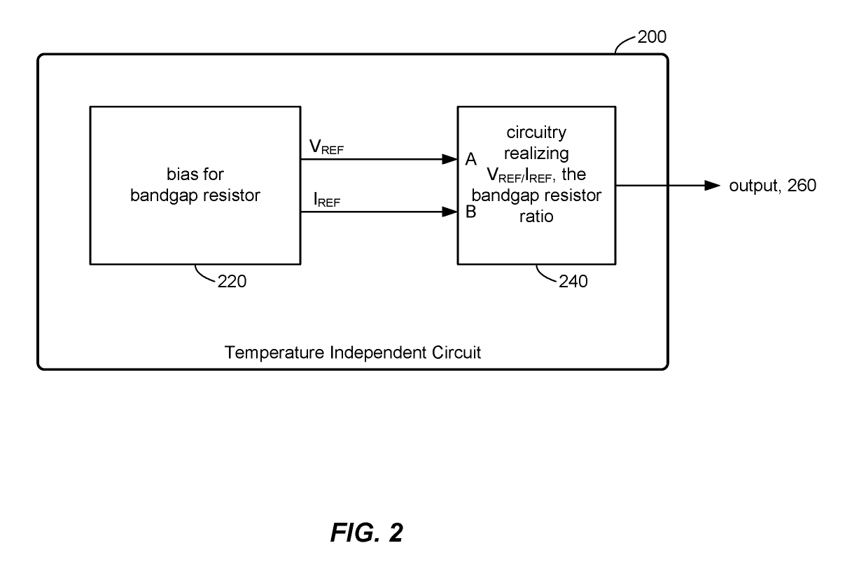

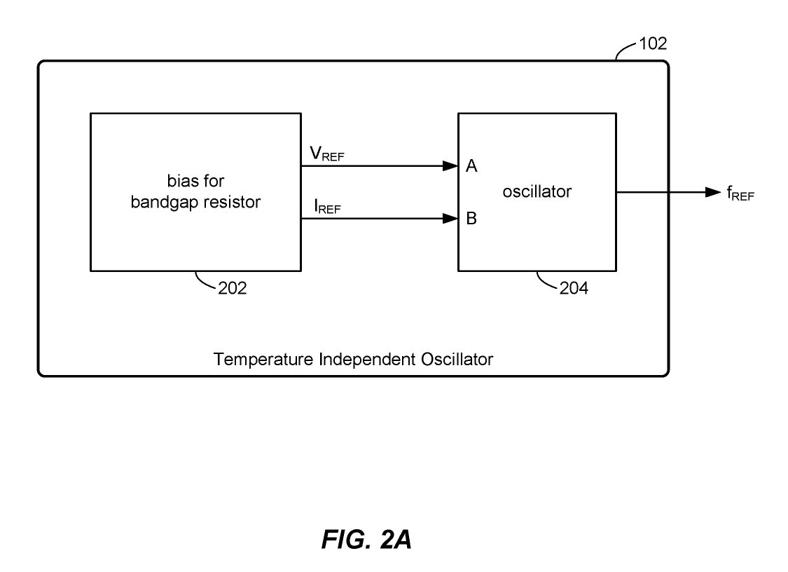

FIG. 2 shows a block diagram of a circuit 200 in accordance with the present disclosure. The circuit 200 may include a bandgap reference (bias) core 220 and circuitry 240. In accordance with the present disclosure, the bandgap reference core 220 may operate to provide a temperature independent bandgap voltage (V_{REF}) and a temperature independent bandgap current (I_{REF}). Accordingly, most circuit imperfections and variations (e.g., due to temperature) are tracked out; i.e., changes in the bandgap voltage and the bandgap current track each other. The circuitry 240 may be characterized in that an output 260 of the circuitry 240 may realize the ratio

$$\frac{{V}_{REF}}{{I}_{REF}} ,$$

which has a unit of resistance. The ratio, which may therefore be referred to as a “bandgap resistor,” is also temperature independent. Because the output 260 of circuit 200 may be expressed in terms of this ratio called bandgap resistor, the output 260 is temperature independent. An instance of the circuit 200 is shown in FIG. 2A, although circuit 200 may be any circuit whose operation can be expressed or otherwise characterized in terms of bandgap resistor ratio, and thus can exhibit temperature independent operation. It is noted that the term “bandgap” typically refers to a process, supply voltage, and temperature (PVT) voltage. As used herein, the term “bandgap” in bandgap resistor may be used to signify only voltage and temperature independence. It is also noted that “temperature independent” is not meant to require absolute independence. A small amount of temperature dependency is contemplated by the term “temperature independent.”

FIG. 2A shows a high level block diagram of TIO 102 (FIG. 1) in accordance with the present disclosure. In some aspects, the TIO 102 may be logically viewed as having two functional sections: a bandgap reference (bias) core 202 and an oscillator section 204. As will be explained in more detail below, the bandgap reference core 202 may operate to provide a temperature independent bandgap voltage (V_{REF}) and a temperature independent bandgap current (I_{REF}). The oscillator section 204 may output a frequency f_{REF} that can be expressed in terms of the ratio

$$\frac{{V}_{REF}}{{I}_{REF}} ,$$

referred to as the bandgap resistance. In accordance with the present disclosure, the bandgap voltage and bandgap current may be generated from the same bias core. Accordingly, most circuit imperfections and variations (e.g., due to temperature) are tracked out. A more detailed description of the bandgap reference core 202 and oscillator section 204 will now be described.

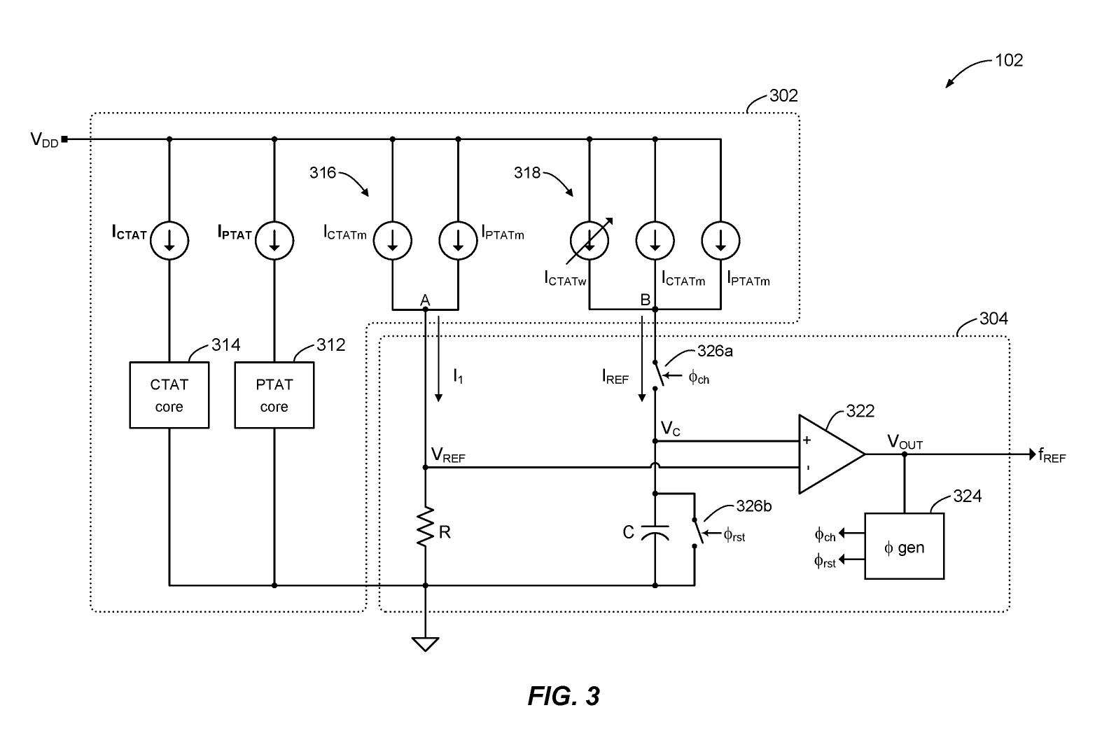

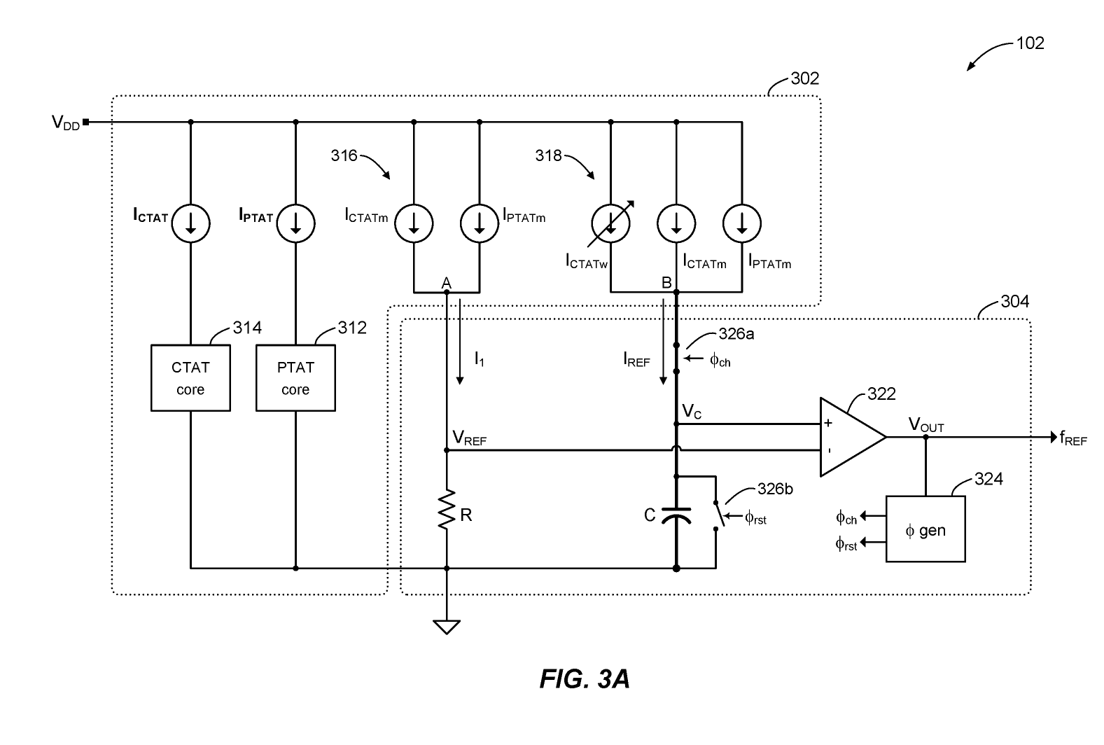

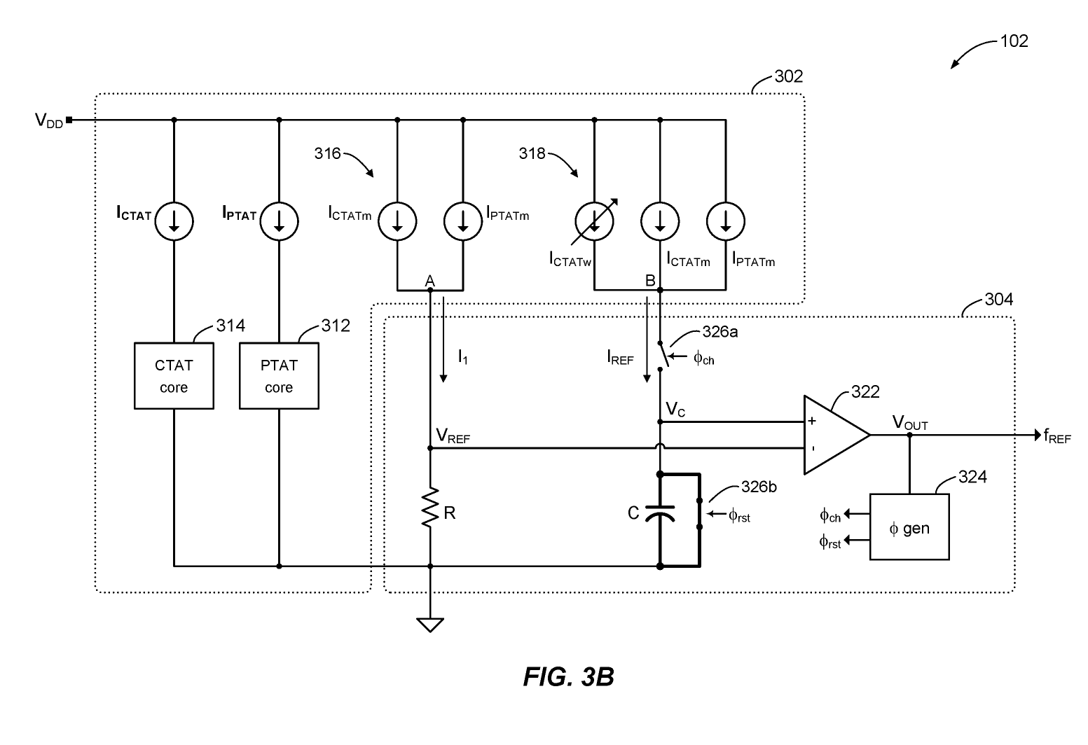

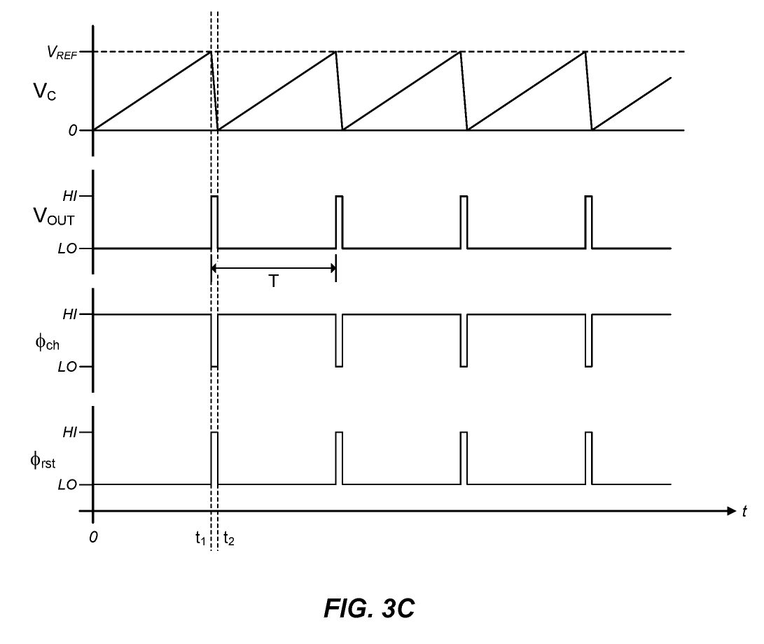

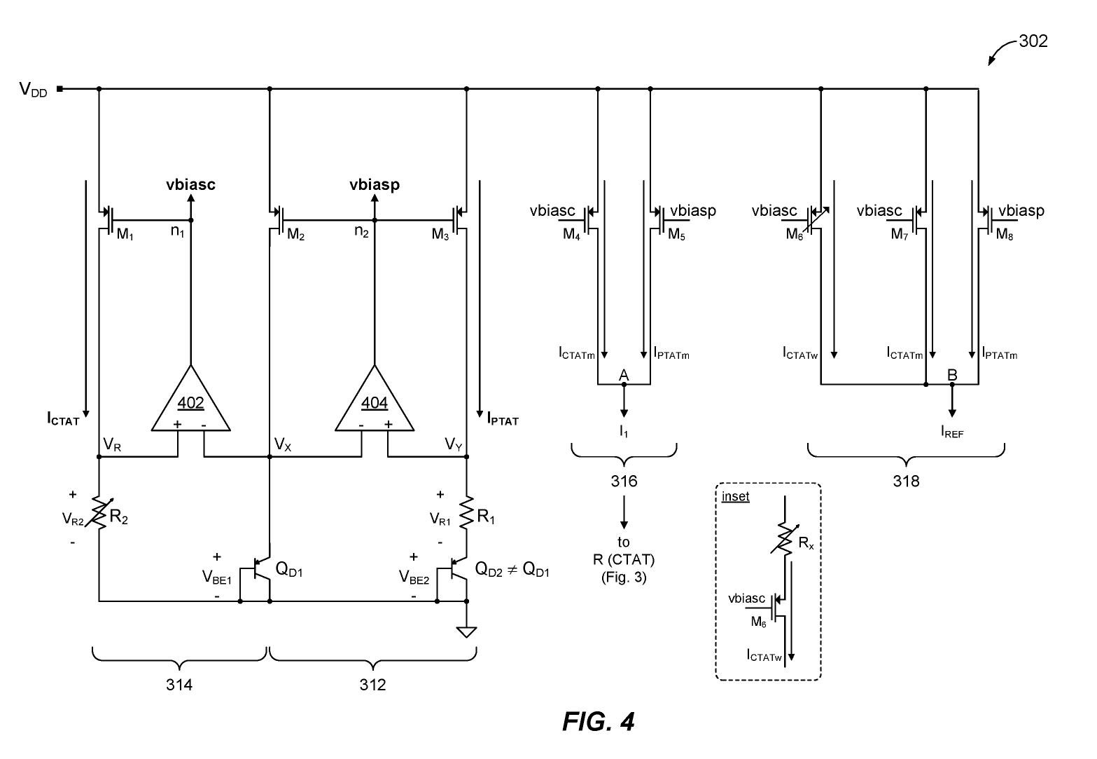

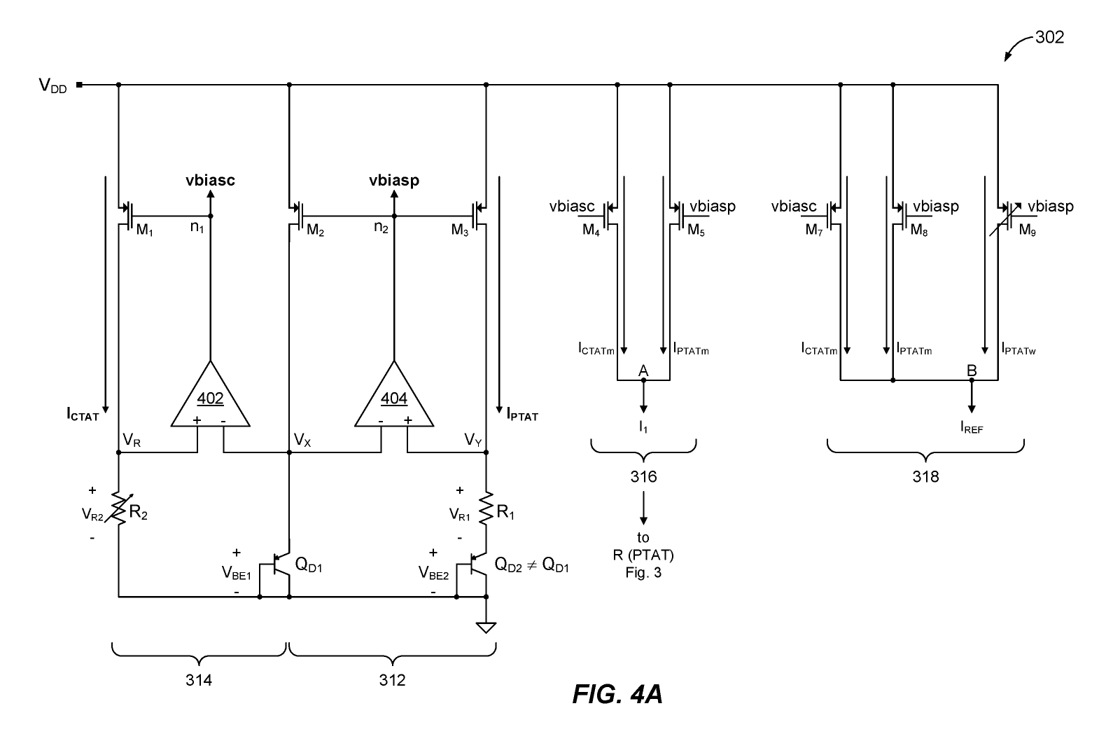

FIG. 3 shows details of a bandgap reference core 302 and an oscillator section 304 in accordance with some aspects of the present disclosure. As explained above the bandgap reference core 302 may generate both a bandgap voltage (V_{REF}) and a bandgap current (I_{REF}) to ensure that circuit imperfections and variations get tracked out. In some aspects, the bandgap reference core 302 may include a complementary to absolute temperature (CTAT) current source 314 and a proportional to absolute temperature (PTAT) current source 312. The CTAT core 314 may generate a current I_{CTAT} that is sensitive to or otherwise varies with changes in temperature. As the name suggests, I_{CTAT} may vary inversely with temperature; in other words, I_{CTAT} generally decreases linearly as temperature increases and vice versa. Similarly, the PTAT core 312 may generate a current I_{PTAT} that is also sensitive to or otherwise varies with temperature, but in opposite relation to I_{CTAT} In other words, whereas I_{CTAT} may vary inversely with temperature, I_{PTAT} may vary directly with temperature; I_{PTAT} generally increases linearly as temperature increases and vice versa.

The bandgap reference core 302 may include a first current summing circuit 316 (e.g., a first current summer) to produce a first summed current I₁ comprising a first combination of I_{PTAT} and I_{CTAT}. In some aspects, for example, the summing circuit 316 may include current generators that mirror I_{CTAT} and I_{PTAT} to produce respective mirrored currents I_{PTATm} and I_{PTATm}. The I_{PTATm} and I_{PTATm} currents may be summed at node A to produce I₁.

The bandgap reference core 302 may include a second current summing circuit 318 (e.g., a second current summer) to produce a second summed current I_{REF} comprising a second combination of I_{PTAT} and I_{CTAT}, and may be referred to as a bandgap current.

In some aspects, for example, the summing circuit 318 may include current generators that mirror I_{CTAT} and I_{PTAT} to produce respective mirrored currents I_{PTATm} and I_{PTATm}. The summing circuit 318 may further include a variable current generator that mirrors I_{CTAT} to generate an additional current. In some aspects, the additional current may comprise a portion of I_{CTAT}. For example, the summing circuit 318 may produce a scaled (weighted) mirrored CTAT current I_{CTATw}. The I_{CTATm}, I_{PTATm}, and I_{CTATw} currents may be summed at node B to produce I_{REF}. This aspect of the present disclosure will be discussed in more detail below.

FIG. 3 shows that the mirrored currents I_{CTATm} and I_{PTATm} generated in the summing circuit 316 are the same as the mirrored currents I_{CTATm} and I_{PTATm} generated in the summing circuit 318. It will be appreciated, however, that in some aspects, these mirrored currents may be scaled differently. In general, the mirrored CTAT current generated in summing circuit 316 may be the same (as in FIG. 3) or different from (greater than or less than) the mirrored CTAT current generated in summing circuit 318. Similarly, the mirrored PTAT current generated in summing circuit 316 may be the same (as in FIG. 3) or different from (greater than or less than) the mirrored PTAT current generated in summing circuit 318. The remaining figures and following discussion and analyses will assume without loss of generality that the mirrored currents I_{CTATm} and I_{PTATm} are equal, in order to avoid overcomplicating the discussion.

In some aspects, the oscillator section 304 may be based on an RC ramp circuit to generate its output V_{OUT}. The oscillator section 304, for example, may include a resistor R and a capacitor C. The resistor R may be connected to the summing circuit 316 and driven by I₁ to produce a voltage V_{REF} across resistor Rat node A. The capacitor C may be connected to switches 326a, 326b. In a first configuration (e.g., FIG. 3A), the capacitor C may be connected to the summing circuit 318 via switch 326a to be charged by I_{REF} to produce a voltage V_{C} across the capacitor C. In a second configuration (e.g., FIG. 3B), capacitor C may be disconnected from the summing circuit 318 and discharged, for example, by shorting capacitor C to ground potential via switch 326b.

The oscillator section 304 may include a comparator 322 to compare the voltage V_{REF} across resistor R and the voltage V_{C} across capacitor C to produce an output V_{OUT}. The output V_{OUT} may flip between a HI output level and a LO output level as the capacitor C cycles between the charging and discharging configurations. In some aspects, the output V_{OUT} of comparator 322 may serve as the reference frequency f_{REF} of the TIO 102.

The oscillator section 304 may include a phase generator 324 to control the OPEN and CLOSED state of switches 326a, 326b. The phase generator 324 may use the output V_{OUT} to generate switch control signals φ_{CH}, φ_{RST} to control the OPEN and CLOSED state of respective switches 326a, 326b. The switches 326a, 326b may operate in opposing (non-overlapping) phases; when one switch (e.g., 326a) is in the OPEN state, the other switch (e.g., 326b) is in the CLOSED state and vice versa.

Operation of the oscillator section 304 can be explained with reference to the timing diagrams shown in FIG. 3C. Consider the charging cycle at time t=0, where the output V_{OUT} of comparator 322 is LO and φ_{CH} is HI (switch 326a is CLOSED) and φ_{RST} is LO (switch 326b is OPEN). In this state, the capacitor C is configured for charging by I_{REF} (e.g., FIG. 3A). The voltage V_{C} across the capacitor C begins to rise as charge accumulates in capacitor C. The voltage V_{C} continues to rise until at time t₁ when the voltage V_{C} becomes equal to the voltage V_{REF} across resistor R and trips the comparator 322. At time t₁, the output V_{OUT} of comparator 322 goes HI, which in turn can flip φ_{CH} to LO (opens switch 326a) and φ_{RST} to HI (closes switch 326b). In this state, the capacitor C is configured for discharging (e.g., FIG. 3B) by disconnecting I_{REF} and shorting capacitor C to ground potential. The discharge time (t₂−t₁) of capacitor C should be short and is exaggerated in the figure to highlight the relative transitions of V_{OUT}, φ_{CH}, and φ_{RST}. This sequence of charging and discharging capacitor C may repeat to generate oscillations at the output V_{OUT}. In some implementations, when V_{C} is discharged at time t₂ the switch can be reconfigured φ_{CH} equal to HI and φ_{RST} equal to LO so that the next charging cycle can begin. The oscillation period may not be affected by the time when the comparator output falls, so long as the comparator output falls prior to when it is next triggered (e.g., when the next ramp of V_{C} reaches a next trip point V_{REF}).

In the single capacitor configuration of FIG. 3, the discharge time (t₂−t₁) is part of the period of oscillations. This discharge time can be very short and hence negligible relative to the oscillation period. Alternatively, charging and discharging two grounded capacitors (instead of one) can occur to exclude the discharge time from the period of oscillations. Similarly, propagation delay through the comparator 322 and phase generator 324 can be made very short relative to the period of oscillations or tracked out through an additional feedback loop so their variation with temperature and supply can be neglected. Thus, in some aspects of the disclosure, the period is substantially set only by the capacitor charging time while the discharge time and comparator propagation delays are excluded from the period analysis or setting.

Referring to FIGS. 3 and 3C, the period T of the oscillations in V_{OUT} may be determined using the capacitor charging equation, which can be expressed as:

$$i = C \frac{Δ v}{Δ t} , \qquad Eqn . ( 1 )$$

where i is I_{REF}, the charging current into capacitor C,
Δv is the voltage V_{REF} across resistor R, and
Δt is the time (period T) it takes to charge capacitor C to the level of V_{REF}.
   Solving for Δt can produce the expression:

$$T ∝ \frac{{V}_{REF}}{{I}_{REF}} C , \qquad Eqn . ( 2 )$$

where T is Δt and represents the period of oscillations, and
V_{REF} depends on I₁ and R.
   In other words, the period of oscillations is proportional to a ratio of V_{REF} to I_{REF}.

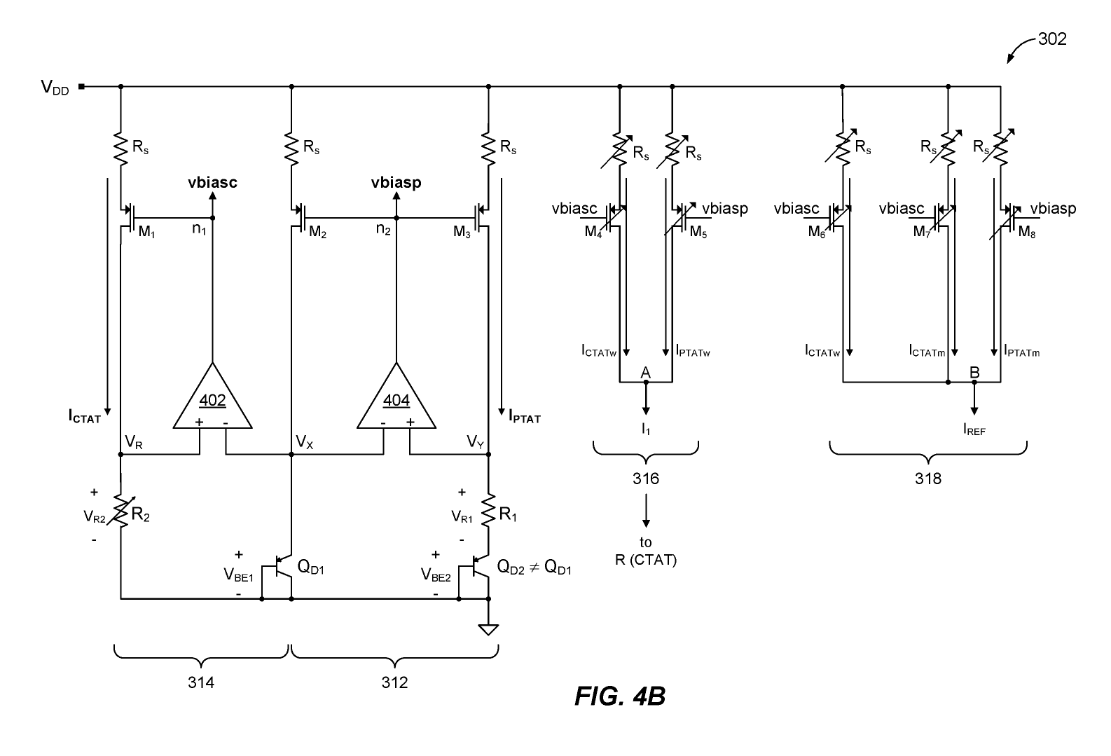

FIG. 4 shows details of the bandgap reference core 302 (FIG. 3) in accordance with some aspects of the present disclosure. As explained above, the bandgap reference core 302 includes a CTAT core 314 and a PTAT core 312. Circuit designs for PTAT and CTAT cores are known. The specific PTAT and CTAT core design disclosed herein is merely an illustrative example to explain aspects of the present disclosure. Persons of ordinary skill will understand that other suitable PTAT and CTAT core designs can be adapted in accordance with the present disclosure. The disclosed CTAT core 314 and a PTAT core 312 generate respective CTAT and PTAT currents. Persons of ordinary skill will appreciate that in some aspects of the present disclosure, the bandgap reference core may comprise CTAT and PTAT cores configured to produce the duals of CTAT and PTAT currents, namely, CTAT and PTAT voltages.

For example, the bandgap reference core generates the CTAT and PTAT voltages, converts them to currents through resistors and sums them in the current domain using two current ratios. In some implementations, the first current ratio is such that it generates the bandgap voltage when converted back to a voltage using a load resistor and the second current ratio is such that it generates the bandgap current. It is noted that “ratio” means that a value varies directly relative to one parameter and is inversely proportional to another parameter.

In some aspects of the disclosure, the bandgap reference core may be configured to be the dual of the above. For example, the bandgap core generates the CTAT and PTAT voltages and sums them in the voltage domain using two voltage ratios. For example, the first voltage ratio is such that it generates the bandgap voltage and the second voltage ratio is such that it generates the bandgap current when converted to a current using a load resistor. An example of this dual implementation is a switched-capacitor based bandgap circuit where capacitors ratios are used to set the voltage ratios.

The PTAT core 312 may include two p-n junctions. In some aspects, for example, the p-n junctions may be realized with diode-connected bipolar junction transistors (BJTs) Q_{D1}, Q_{D2} of different sizes, where the p-n junctions are the base-emitter junctions of Q_{D1} and Q_{D2}. It will be appreciated that in some aspects, devices other than BJTs may be used to create the p-n junctions (e.g., diodes).

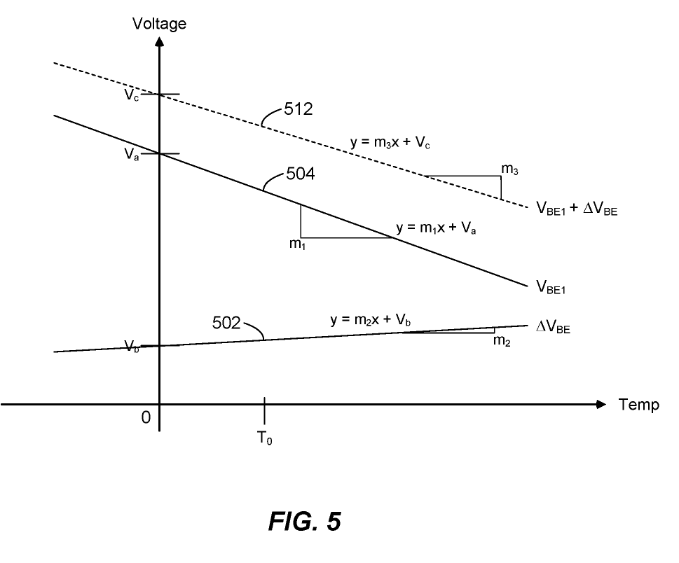

In some aspects, the PTAT core 312 may include a self-biased circuit comprising an opamp 404 and PMOS devices M2 and M3. A PTAT current I_{PTAT} may be generated by forcing a voltage difference ΔV_{BE1} between the p-n junction potential (e.g., base-emitter voltage, V_{BE1}) of Q_{D1} and the p-n junction potential (e.g., base-emitter voltage, V_{BE2}) of Q_{D2} across resistor R₁. The voltage V_{Y} at one input (e.g., non-inverting input) of the opamp 404 comprises the sum of the p-n junction potential V_{BE2} of Q_{D2} and the voltage V_{R1} across resistor R₁. The voltage V_{X} at the other input (e.g., inverting input) of opamp 404 is the p-n junction potential V_{BE1} of Q_{D1}. The PMOS devices M2 and M3 mirror I_{PTAT} down the V_{X} branch (e.g., first circuit branch) and the V_{Y} branch (e.g., second circuit branch). The opamp 404 uses the difference between voltages V_{X} and V_{Y} to produce a bias voltage vbiasp to bias M2 and M3 such that the flow of I_{PTAT} in both the V_{X} branch and the V_{Y} branch equalizes the voltages V_{X} and V_{Y}. The difference ΔV_{BE} between V_{BE1} and V_{BE2} varies in direct proportion to temperature (e.g., 502, FIG. 5); ΔV_{BE} increases with an increase in temperature and vice versa (e.g., 502, FIG. 5). Because ΔV_{BE} is typically more strongly PTAT (relative to resistor R1), I_{PTAT} is also directly proportional to temperature.

In some aspects, the CTAT core 314 may include opamp 402 and PMOS device M1. A CTAT current I_{CTAT} may be generated by forcing the p-n junction potential V_{BE1} of Q_{D1} across resistor R₂. In some aspects, resistor R₂ may be a variable resistor that can be adjusted to make V_{REF} a bandgap voltage. The voltage V_{R} at one input of opamp 402 is the voltage across resistor R₂, and the voltage at the other input of opamp 402 is the voltage V_{X}, namely the p-n junction potential V_{BE1}. The PMOS device M1 controls I_{CTAT} in the V_{R} branch (e.g., third circuit branch). The opamp 402 uses the difference between voltages V_{R} and V_{X} to generate a bias voltage vbiasc to bias M1 such that the flow of I_{CTAT} in both the V_{X} branch and the V_{R} branch equalizes the voltages V_{X} and V_{R}. The voltage V_{BE1} varies inversely with temperature; V_{BE1} decreases linearly with an increase in temperature and vice versa (e.g., 504, FIG. 5). Accordingly, I_{CTAT} also varies inversely with temperature. Because V_{BE1} is typically more strongly CTAT (compared to resistor R2), I_{CTAT} also varies inversely with temperature.

Continuing with FIG. 4, the bandgap reference core 302 may include summing circuit 316. In some aspects, the summing circuit 316 may include a PMOS device M4 to mirror the CTAT current I_{CTAT} and a PMOS device M5 to mirror the PTAT current I_{PTAT}. For example, the PMOS device M4 may be biased using the bias voltage vbiasc generated by the CTAT core 314 to produce a mirrored CTAT current I_{CTATm}. Similarly, the PMOS device M5 may be biased using the bias voltage vbiasp generated by the PTAT core 312 to produce a mirrored PTAT current I_{PTATm}. The mirrored currents I_{CTATm} and I_{PTATm} can be summed or otherwise combined at node A in the summing circuit 316 to produce the I₁ current.

The bandgap reference core 302 may include summing circuit 318. In some aspects, the summing circuit 318 may include a PMOS device M7 to mirror the CTAT current I_{CTAT} and a PMOS device M8 to mirror the PTAT current I_{PTAT}. For example, the PMOS device M7 may be biased using the bias voltage vbiasc generated by the CTAT core 314 to produce a mirrored CTAT current I_{CTATm}. Similarly, the PMOS device M8 may be biased using the bias voltage vbiasp generated by the PTAT core 312 to produce a mirrored PTAT current I_{PTATm}. The summing circuit 318 may further include a variable current generator that mirrors I_{CTAT} to produce a scaled (weighted) mirrored CTAT current I_{CTATw} (explained below), which represents a portion of I_{CTAT}. In some aspects, for example, the variable current generator may include a variable PMOS device M6 having multiple fingers that can be programmatically selected. In other aspects, the variable current generator may include a variable resistor R_{X} (inset) connected in series with a fixed M6. The mirrored currents I_{CTATw}, I_{CTATm}, and I_{PTATm} can be summed or otherwise combined at node B to produce the I_{REF} current.

As shown in FIG. 4, in some aspects the bandgap reference core 302 may be realized using PMOS devices M1-M8. It will be appreciated that in other aspects, the devices M1-M8 may be realized using NMOS devices. For the remaining figures and the following discussion, devices M1-M8 can be assumed to be PMOS devices without loss of generality.

Referring again to FIG. 3, in accordance with the present disclosure, capacitor C in the oscillator section 304 can be made temperature invariant. For example, fringe capacitors have a near-zero temperature coefficient because their capacitance is a function of geometric and material properties that vary little with temperature. Metal-oxide-metal (MOM) capacitors, for example, can have zero tempco. Temperature coefficient (“tempco”) generally refers to a factor that relates a change in a quantity (e.g., capacitance) to a change in temperature, and can be a positive value or a negative value. A positive tempco indicates the quantity is directly proportional to temperature (e.g., capacitance increases as temperature increases and vice versa), and a negative tempco indicates the quantity varies inversely with temperature (e.g., capacitance decreases as temperature increases and vice versa). A zero tempco indicates the quantity does not change (is invariant) with temperature.

By contrast, the resistor R in the oscillator section 304, in accordance with the present disclosure, may be realized using a temperature sensitive (non-zero tempco) resistor. Depending on the particular materials used, the resistor R may have PTAT behavior (resistance varies directly with temperature) or CTAT behavior (resistance varies inversely with temperature). Relaxing the temperature constraint on resistor R allows for a simpler and lower cost design resistor as compared to a design that imposes a requirement of temperature invariance; e.g., a zero tempco resistor may be realized by combining resistors having equal and opposite tempcos, possibly adding complexity to the fabrication process, and the like. In some technologies, it may not be practical or possible to make a temperature invariant resistor. For example, FinFET fabrication generally cannot provide resistor designs that have opposite tempcos and so the approach of creating a zero tempco resistor using resistors with opposite tempcos may not be available.

As explained above, the period T (and hence the frequency) of f_{REF} is primarily set by the RC product as indicated in Eqn. 2 (I₁ and I_{REF} are based on the PTAT and CTAT cores 312, 314). If a temperature sensitive resistor is used, then temperature variations will affect resistor R, which in turn can result in corresponding fluctuations in f_{REF}.

In accordance with the present disclosure, summing circuit 316 may be configured to generate a current I₁ having a temperature sensitivity that is in opposite relation to the temperature sensitivity of resistor R. For example, if resistor R is PTAT, then I₁ can be CTAT so that an increase in resistance due to a temperature increase can be matched by a decrease in h. Conversely, if resistor R is CTAT, then I₁ can be PTAT so that a decrease in resistance due to a temperature increase can be matched by an increase in h. In other words, I₁ may be characterized with a tempco (α) that is equal to but opposite in sign to the tempco (−α) of the resistor R. Thus, an x % change in the resistance of resistor R in one direction (increase or decrease) can be matched by an x % change in I₁ in the opposite direction. Accordingly, when I₁ is driven into resistor R, the resulting voltage V_{REF} across resistor R can be temperature invariant. Without loss of generality, the configuration depicted in the figures (e.g., FIGS. 3, 4) assume resistor R is CTAT, and so I₁ is PTAT.

In accordance with the present disclosure, the summing circuit 318 may generate an I_{REF} that is temperature invariant. The summing circuit 318 may produce a current I_{REF} that is the sum of the mirrored currents I_{CTATm}, I_{CTATw}, and I_{PTATm}. As explained above, in accordance with the present disclosure I₁, which is the sum of I_{CTATm} and I_{PTATm}, may vary with temperature. For example, as noted above, the configuration shown in FIG. 4 assumes resistor R is CTAT and so I₁ is PTAT. Accordingly, the sum of the mirrored currents I_{CTATm} and I_{PTATm} in the summing circuit 318 is also PTAT. Accordingly, in some aspects, additional CTAT current may be added to make I_{REF} a bandgap current. For example, the summing circuit 318 may generate a current I_{CTATw} that is scaled so as to offset the PTAT behavior of the sum of the mirrored currents I_{CTATm} and I_{PTATm} in summing circuit 318, resulting in an I_{REF} current that is temperature independent.

Referring to FIG. 4A, in other aspects, the bandgap reference core 302 may be configured for a resistor R that is PTAT. Accordingly, I₁ would be CTAT, and so the sum of the mirrored currents I_{CTATm} and I_{PTATm} in the summing circuit 318 would also CTAT. In accordance with the present disclosure, the summing circuit 318 may add extra PTAT current to make I_{REF} a bandgap current. For example, summing circuit 318 may include a variable PMOS device M9 to generate a weighted mirrored PTAT current I_{PTATw} that is scaled so as to offset the CTAT behavior of I_{CTATm}+I_{PTATm} in summing circuit 318, resulting in an I_{REF} current that is insensitive to temperature. The remaining discussion, however, can assume the configuration of FIG. 4 without loss of generality.

Referring to FIG. 4B, a more general configuration of the bandgap reference core 302 may include variable PMOS devices M₄-M₈ to generate the bandgap voltage V_{REF} and bandgap current I_{REF}. The bandgap reference core 302 may include degeneration resistors R_{S} to suppress current mismatch in the PMOS devices M₁-M₈. One or more of the degeneration resistors RS may be programmable or variable to adjust mirroring ratios.

Recall from above that the period T of reference frequency f_{REF} (output of TIO 102) can be expressed in terms of V_{REF} and I_{REF}. Eqn. 2 above, for example, expresses this relation as follows:

$$T ∝ \frac{{V}_{REF}}{{I}_{REF}} C .$$

As explained, the capacitor C can be a temperature invariant device. Likewise, a temperature invariant V_{REF} and a temperature invariant I_{REF} can be generated. Since the period T can be determined based on terms (V_{REF}, I_{REF}) that are temperature invariant, the TIO 102, in accordance with the present disclosure, can provide a reference frequency f_{REF} that is also temperature invariant. In particular, a temperature invariant f_{REF} can be advantageously produced without imposing the constraint that the design employs a temperature invariant resistor R. This and other advantages are discussed further below.

The discussion will now continue with a more qualitative description of operation of the TIO 102, with reference to FIGS. 3 and 4 and with an emphasis on operation of the bandgap reference core 302 in accordance with aspects of the present disclosure. The equations and analyses present below generally represent first-order approximations of actual circuit behavior, and are intended to be illustrative of circuit operation in accordance with the present disclosure.

From Eqn. 2, the period T of the reference frequency f_{REF} from TIO 102 may be expressed as:

$$T ∝ \frac{{V}_{REF}}{{I}_{REF}} C .$$

The expression may be rewritten as:

$$\begin{matrix}T ∝ {R}_{REF} C , where & Eqn . ( 3 ) \\ {R}_{REF} = \frac{{V}_{REF}}{{I}_{REF}} . & Eqn . ( 4 )\end{matrix}$$

Given that V_{REF}=I₁R, R_{REF} may also be expressed as:

$${R}_{REF} = R \frac{{I}_{1}}{{I}_{REF}} . \qquad Eqn . ( 5 )$$

As noted above, the ratio R_{REF} may be referred to as a “bandgap resistor.” Equation 3 therefore expresses an operation of TIO 102 in terms of the bandgap resistor ratio. In particular, the bandgap resistor R_{REF} characterizes an operation of the TIO 102, namely R_{REF} in combination with the capacitor C sets an operating frequency of the TIO 102.

As noted above, while capacitor C may be made temperature invariant, it may be not desirable (or practical) to impose a requirement on resistor R that it also be temperature invariant. Accordingly, in accordance with the present disclosure, resistor R may be allowed vary with temperature. Resistor R may be modeled as:

R=R₀(1+αΔT), Eqn. (6)

where R is the resistance at a temperature T (e.g., circuit operating temperature),
R₀ is the resistance at a reference temperature T₀ (e.g., room temperature),
α is a temperature coefficient of resistor R, and
ΔT is T−T₀.

As explained above, the currents I₁ and I_{REF} are derived from I_{PTAT} and I_{PTAT}. Referring to FIG. 4, I_{PTAT} may be expressed in terms of resistor R₁ in the following derivation. By operation of opamp 404:

V_{BE1}=V_{R1}+V_{BE2}, Eqn. (7)

where V_{BE1} and V_{BE2} are the p-n junction potentials of Q_{D1} and Q_{D2}, respectively, and
V_{R1} is the voltage across resistor R₁.
   The voltage V_{R1}, in turn, can be expressed as:

$$\begin{matrix}{V}_{R 1} = {V}_{BE 2} - {V}_{BE 1} \\ = Δ {V}_{BE}\end{matrix} \qquad Eqn . ( 8 )$$

Voltage V_{R1} can also be expressed in terms of I_{PTAT} as:

V_{R1}=I_{PTAT}×R₁ Eqn. (9)

Combining Eqns. 8 and 9 produces the following expression for I_{PTAT} in terms of R₁:

$${I}_{PTAT} = \frac{Δ {V}_{BE}}{{R}_{1}} \qquad Eqn . ( 10 )$$

The CTAT current I_{CTAT} may be similarly expressed in terms of resistor R₂ as follows:

$$\begin{matrix}{V}_{R 2} = {V}_{BE 1} & Eqn . ( 11 ) \\ {V}_{R 2} = {I}_{CTAT} \times {R}_{2} & Eqn . ( 12 ) \\ {I}_{CTAT} = \frac{{V}_{BE 1}}{{R}_{2}} & Eqn . ( 13 )\end{matrix}$$

The mirrored currents I_{CTATm} and I_{PTATm} in the summing circuits 316, 318 may be represented by Eqns. 10 and 13, respectively.

The current I₁ from summing circuit 316 comprises I_{PTATm} I_{PTATm}, which may be expressed using Eqns. 10 and 13 as:

$$\begin{matrix}{I}_{1} = {w}_{1} \frac{{V}_{BE 1}}{{R}_{2}} + \frac{Δ {V}_{BE}}{{R}_{1}} \\ = \frac{1}{{R}_{1}} ( {w}_{1} \frac{{R}_{1}}{{R}_{2}} {V}_{BE 1} + Δ {V}_{BE} ) ,\end{matrix} \qquad Eqn . ( 14 )$$

where w₁ is a weighting term.
A mentioned above, I_{CTAT} and I_{PTAT} may be weighted (e.g., in the respective PTAT and CPTAT cores 312, 314) in accordance with the present disclosure such that the sum of I_{CTATm} and I_{PTATm} in summing circuit 316 produces an I₁ having the temperature properties described above in relation to resistor R, namely that I₁ varies with respect to temperature by the same amount as does resistor R, but in opposite relation. It will become apparent in the discussion below that this property of I₁ can be achieved by setting the weighting term w₁. In some aspects, I_{CTAT} and I_{PTAT} may be weighted relative to each other by applying the weighting term w₁ to the I_{CTAT} current, as shown in Eqn. 14. It will be appreciated that in other aspects, the weighting term w₁ may be applied to the I_{PTAT} current.

The current I_{REF} from summing circuit 318 comprising I_{CTATm} I_{CTATw}+I_{PTATm} may be expressed using Eqns. 10 and 13:

$$\begin{matrix}{I}_{REF} = {w}_{2} \frac{{V}_{BE 1}}{{R}_{2}} + \frac{Δ {V}_{BE}}{{R}_{1}} \\ = \frac{1}{{R}_{1}} ( {w}_{2} \frac{{R}_{1}}{{R}_{2}} {V}_{BE 1} + Δ {V}_{BE} ) ,\end{matrix} \qquad Eqn . ( 15 )$$

where w₂ is a weighting term>1.
In accordance with the present disclosure, the

$${w}_{2} \frac{{V}_{BE 1}}{{R}_{2}}$$

term may represent the combined current in the I_{CTATm} and I_{CTATw} branches in the summing circuit 318.

Substituting Eqns. 14 and 15 into Eqn. 5 yields:

$${R}_{ref} = R \frac{{n}_{1} {V}_{BE 1} + Δ {V}_{BE}}{{n}_{2} {V}_{BE 1} + Δ {V}_{BE}} , where \\ {n}_{1} = {w}_{1} \frac{{R}_{1}}{{R}_{2}} and {n}_{2} = {w}_{2} \frac{{R}_{1}}{{R}_{2}} . \qquad Eqn . ( 16 )$$

Substituting R in Eqn. 16 with the expression in Eqn. 6 yields:

$${R}_{ref} = {R}_{0} ( 1 + αΔ T ) \frac{{V}_{1}}{{V}_{2}} , \qquad Eqn . ( 17 )$$

where V₁=n₁V_{BE1}+ΔV_{BE},

and

V₂=n₂V_{BE1}+ΔV_{BE}.

Referring for a moment to FIG. 5, persons of skill will understand that the slope characteristics of V_{BE1} and ΔV_{BE} with respect to temperature are predictable and well understood. For example, ΔV_{BE} may be represented (as a first-order approximation) by a straight line plot 502 relating voltage vs. temperature. Similarly, V_{BE1} may be represented by a straight line plot 504. With respect to Eqn. 17, the n₁V_{BE1} and n₂V_{BE1} terms may also be represented by straight lines similar to plot 504, except that the multiplication factors n₁, n₂ alter the slopes and the intersection points on the voltage axis. The straight line plot 512 in FIG. 5 represents the sum of V_{BE1} and ΔV_{BE}. Accordingly with respect to Eqn. 17, the V₁ and V₂ terms may also be represented by straight lines similar to plot 512, with the multiplication factors n₁, n₂ taken into consideration.

The straight line representations for V₁ and V₂ can be normalized to respective nominal voltages V₁⁰ and V₂⁰ at a reference temperature T₀ (e.g., room temperature). V₁ and V₂ can be expressed in terms of change relative to their nominal voltages (V₁⁰ and) V₂⁰ vs. changes in temperature (ΔT) relative to the reference temperature T₀.

Accordingly, each of the expressions for V₁ and V₂ in Eqn. 17 can be expressed in terms of a fractional change from the nominal voltages V₁⁰ and V₂⁰:

V₁=V₁⁰(1+β₁ΔT)

V₂=V₂⁰(1+β₂ΔT), Eqn. (18)

where V₁⁰ and V₂⁰ are nominal voltages at the reference temperature T₀,
β₁ and β₂ are effective temperature coefficients, and
ΔT is the temperature difference (T−T₀).
   Equation (18) relating to V₂, for example, can be expanded as follows:

V₂=(V₂⁰+V₂⁰β₂ΔT Eqn. (19)

It can be shown that the β₁ and β₂ terms represent the slopes of the respective straight line plots (e.g., FIG. 5) that represent (n₁V_{BE1}+ΔV_{BE}) and (n₂V_{BE1}+ΔV_{BE}) normalized to respective nominal voltages V₁⁰ and V₂⁰. Substituting Eqn. 18 into Eqn. 17 yields:

$${R}_{REF} = {R}_{0} ( 1 + αΔ T ) \frac{{V}_{1}^{0} ( 1 + {β}_{1} Δ T )}{{V}_{2}^{0} ( 1 + {β}_{2} Δ T )} , \qquad Eqn . ( 20 )$$

where R_{REF} is computed for a temperature T (e.g., circuit operating temperature), and
R₀ is the resistance of resistor R (Eqn. 6) at the reference temperature T₀,
α is a temperature coefficient of resistor R, and
ΔT is the temperature difference (T−ΔT).
   Setting β₁ equal to 0 and β₂ equal to a, reduces Eqn. 20 to:

$${R}_{REF} = {R}_{0} \frac{{V}_{1}^{0}}{{V}_{2}^{0}} , \qquad Eqn . ( 21 )$$

which is an expression that contains no dependency to changes in temperature and is thus temperature invariant. Recall from Eqn. 4 that R_{REF} can be expressed as:

$${R}_{REF} = \frac{{V}_{REF}}{{I}_{REF}} ,$$

which is an expression of Ohm's law for resistors. R_{REF} therefore represents a resistive term, and because R_{REF} is temperature invariant as shown above, R_{REF} may be referred to as a “bandgap resistor.” Tying back to the reference frequency f_{REF} in FIG. 3, Eqn. 3 shows that the period T of f_{REF} may be expressed in terms of this bandgap resistor:

T∝R_{REF}C.

Since the bandgap resistor term is temperature invariant and the capacitor C is temperature invariant, the resulting period T is also temperature invariant.

The discussion will now turn to a description that relates the β₁ and β₂ terms to circuit elements comprising the TIO 102. A derivation will be described for β₁ with the understanding that a similar derivation can be made for β₂.

Consider first the β₁ term. Recall from Eqns. 16 and 17 that V₁ is defined as:

$${V}_{1} = {n}_{1} {V}_{BE 1} + Δ {V}_{BE} , \\ where {n}_{1} = {w}_{1} \frac{{R}_{1}}{{R}_{2}} . \qquad Eqn . ( 22 )$$

Referring to FIG. 5, V_{BE1} and ΔV_{BE} can be represented (as a first-order approximation) by the straight line equation y=mx+b as follows:

V_{BE1}:y=m₁×x+Vₐ

ΔV_{BE}:y=m₂×x+V_{b}, Eqn. (23)

where m₁ is the slope of the V_{BE1} line, and
m₂ is the slope of the A V_{BE} line.
   Using Eqns. 22 and 23, the sum V₁ can similarly be represented by a straight line equation:

V₁:y=m₃×x+V_{c}, Eqn. (24)

where m₃ is the slope of the V₁ line, which can be expressed as

$${w}_{1} \frac{{R}_{1}}{{R}_{2}} {m}_{1} + {m}_{2} .$$

Normalizing V₁, the β₁ term may then be expressed as:

$${β}_{1} = \frac{1}{{V}_{1}^{0}} ( {w}_{1} \frac{{R}_{1}}{{R}_{2}} {m}_{1} + {m}_{2} ) . \qquad Eqn . ( 25 )$$

As explained above in connection with Eqns. 20 and 21, setting β₁=0 can generate a V₁ that is temperature invariant. Solving Eqn. 25 for β₁=0 results in the following:

$${w}_{1} \frac{{R}_{1}}{{R}_{2}} = - \frac{{m}_{2}}{{m}_{1}} . \qquad Eqn . ( 26 )$$

The w₁ weighting term can be set to one since the term in this case only serves to scale the resistor values R1, R2. Eqns. 5, 14, and 17 show that V_{REF} ∝V₁. Therefore, in accordance with the present disclosure, the ratio of resistors R₁ and R₂ in bandgap reference core 302 may be set according to the ratio of the slopes of V_{BE1} and A V_{BE} to generate I_{PTAT} and I_{PTAT} currents that are weighted such that when the sum of I_{CTAT} and I_{PTAT} are driven into resistor R, the voltage V_{REF} across resistor R can be temperature invariant.

Consider next the β₂ term. Recall from Eqns. 16 and 17 that V₂ is defined as:

$${V}_{2} = {n}_{2} {V}_{BE 1} + Δ {V}_{BE} , \\ where {n}_{2} = {w}_{2} \frac{{R}_{1}}{{R}_{2}} . \qquad Eqn . ( 27 )$$

Referring to FIG. 5, V_{BE1} and ΔV_{BE} can be represented (as a first-order approximation) by the straight line equation y=mx+b as shown in FIG. 23.

where m₁ is the slope of the V_{BE1} line, and
m₂ is the slope of the A V_{BE} line.
   Using Eqns. 27 and 23, the sum V₂ (like V₁) can similarly be represented by a straight line equation:

V₂:y=m₃×x+V_{c}, Eqn. (28)

From equation 27, 23 and 28,

$${V}_{2} = {w}_{2} \frac{{R}_{1}}{{R}_{2}} ( {m}_{1} x + {V}_{a} ) + {m}_{2} x + {V}_{b}$$

$${V}_{2} = ( {w}_{2} \frac{{R}_{1}}{{R}_{2}} {m}_{1} + {m}_{2} ) x + {m}_{2} \frac{{R}_{1}}{{R}_{2}} {V}_{a} + {V}_{b}$$

where, in this case, m₃ is the slope of the V₂ line, which can be expressed as

$${w}_{2} \frac{{R}_{1}}{{R}_{2}} {m}_{1} + {m}_{2} .$$

As noted, it can be shown that the β₁ and β₂ terms represent the slopes of the respective straight line plots (e.g., FIG. 5) that represent (n₁V_{BE1}+ΔV_{BE}) and (n₂V_{BE1}+ΔV_{BE}) normalized to respective nominal voltages V₁⁰ and V₂⁰.
Based on equation 18

$${V}_{2}^{0} = {w}_{2} \frac{{R}_{1}}{{R}_{2}} {V}_{a} + {V}_{b} \qquad Eqn . ( 29 )$$

Consider next the β₂ term. Similar to Eqn. 25, normalizing β₂, the β₂ term may be expressed as:

$${β}_{2} = \frac{1}{{V}_{2}^{0}} ( {w}_{2} \frac{{R}_{1}}{{R}_{2}} {m}_{1} + {m}_{2} ) . \qquad Eqn . ( 30 )$$

As shown in Eqn. 21, setting β₂=a allows for the coefficient terms (1+αΔT) and (1+β₂ΔT) to cancel out, thus generating a V₂ that changes with resistor R as temperature changes. Because the R₁ and R₂ resistors have been solved according to Eqn. 25, they are deemed fixed quantities. Accordingly, Eqn. 30 may be solved for the w₂ weighting term where β₂=a, which results in the following:

$${w}_{2} = \frac{{R}_{2}}{{R}_{1}} \frac{α {V}_{2}^{0} - {m}_{2}}{{m}_{1}} . \qquad Eqn . ( 31 )$$

Substituting for V₂⁰ from equation 29 and solving for w₂, we get

$${w}_{2} = \frac{{R}_{2}}{{R}_{1}} \frac{( α {V}_{b} - {m}_{2} )}{( {m}_{1} - α {V}_{a} )} \qquad Eqn . ( 32 )$$

Because all the quantities on the right hand side are known in equation 32, the appropriate w₂ can be computed for a given design.
Referring to FIG. 4, in accordance with the present disclosure, the w₂ weighting term may be used to program the variable resistor R_{X} to generate I_{CTATw}.

### CONCLUSION

In accordance with the present disclosure, a voltage and temperature stable oscillator is presented. A calibration engine provides correction for process variations, resulting in an oscillator that is “PVT” stable.

Various aspects of the present disclosure ensure against fluctuations due to circuit imperfections and process variation. For example, traditional bandgap designs focus on building a voltage (or current) with very high absolute precision. Absent advanced design techniques, this precision is limited by various imperfections, such as inherent nonlinearity of V_{BE} with temperature, process dependent curvature artifacts, offsets/mismatch, etc. In order to achieve sub 1% accuracy, more advanced schemes (like non-linear curvature compensation, chopping, etc.) are incorporated into a design, typically at the cost of complexity, area, and power.

In contrast, aspects of a bandgap reference core 302 (FIG. 4) in accordance with the present disclosure are based on building a high precision resistor (bandgap resistor, R_{REF}), which is a ratio of a voltage (V_{REF}) and a current (I_{REF}) which can be re-arranged as a ratio of two voltages. From Eqns. 16 and 17, recall that:

$$\begin{matrix}{R}_{REF} = R \frac{{n}_{1} {V}_{BE 1} + Δ {V}_{BE}}{{n}_{2} {V}_{BE 1} + Δ {V}_{BE}} \\ = R \frac{{V}_{1}}{{V}_{2}} .\end{matrix}$$

Since this expression relies on a ratio, the numerator and denominator do not need very high absolute precision or linearity, but rather should track each other as much as possible. Notice that this can be realized this by generating the two summed currents identically so that they track each other except to cancel the tempco of resistor R. This is an advantage of the bandgap reference core 302 giving it immunity to circuit imperfections that arise from the bandgap reference core 302.

In addition, because we can precisely set a zero tempco on the frequency (by canceling the resistor's tempco), we can also intentionally set a non-zero tempco to the output frequency using this approach. For example, it may be desirable to decrease the clock frequency when hot because downstream ICs typically run slower when hot.

The above description illustrates various embodiments of the present disclosure along with examples of how aspects of the particular embodiments may be implemented. The above examples should not be deemed to be the only embodiments, and are presented to illustrate the flexibility and advantages of the particular embodiments as defined by the following claims. Based on the above disclosure and the following claims, other arrangements, embodiments, implementations and equivalents may be employed without departing from the scope of the present disclosure as defined by the claims.

What is claimed is:

1. A circuit comprising:
a first current generator configured to generate a first current that varies with temperature;
a second current generator configured to generate a second current that varies with temperature in opposite relation to the first current;
a voltage generating circuit connected to the first current generator and the second current generator and having an output for a bandgap voltage based on the first current and the second current;
a current generating circuit connected to the first current generator and the second current generator and having an output for a bandgap current based on the first current and the second current;
a capacitor selectively configurable in a first configuration to receive the bandgap current to charge the capacitor and a second configuration to discharge the capacitor; and
a comparator configured to produce a comparator signal based on the bandgap voltage and a capacitor voltage across the capacitor, the capacitor being configured in the first configuration and the second configuration in response to the comparator signal, the comparator signal varying in time in response to the capacitor being charged and discharged, the comparator signal having a period that is based at least in part on the bandgap voltage across a resistor and the bandgap current.

2. The circuit of claim 1, wherein the voltage generating circuit comprises a first circuit branch to mirror the first current, a second circuit branch to mirror the second current, and the resistor connected to the first circuit branch and the second circuit branch at a node, wherein the bandgap voltage is a voltage at the node when current flows from the first circuit branch and the second circuit branch into the resistor.

3. The circuit of claim 2, wherein the resistor varies with temperature and the current that flows into the resistor varies with temperature in opposite relation to the resistor.

4. The circuit of claim 1, further comprising a frequency generator configured to produce an output signal using the comparator signal as a reference frequency.

5. The circuit of claim 4, further comprising a calibration engine having an input to receive an external reference frequency and the comparator signal, the calibration engine configured to produce a multiplier based on the external reference frequency and a frequency of the comparator signal, the output signal having a frequency equal to the frequency of the comparator signal times the multiplier.

6. A circuit comprising:
an RC oscillator comprising a proportional to absolute temperature (PTAT) core and a complementary to absolute temperature (CTAT) core configured to generate a bandgap voltage and a bandgap current, the RC oscillator configured to generate a temperature invariant reference frequency having a period that is based on the bandgap voltage and the bandgap current;
a frequency generator; and
a calibration engine having an output for a multiplier and configured to produce the multiplier based on the temperature invariant reference frequency of the RC oscillator and an external reference frequency,
the frequency generator configured to generate an output signal by regulating a frequency of the output signal to the temperature invariant reference frequency of the RC oscillator times the multiplier to produce a temperature invariant output frequency.

7. The circuit of claim 6, wherein the multiplier represents a result obtained by dividing the external reference frequency divided by the temperature invariant reference frequency of the RC oscillator.

8. The circuit of claim 6, wherein the frequency generator is a phase locked loop or a digital frequency locked loop.

9. The circuit of claim 6, wherein the RC oscillator further comprises a first current summer connected to the PTAT and CTAT cores and a resistor connected to receive a current from the first current summer, wherein the current varies with temperature and the resistor varies with temperature in opposite relation to the current, wherein the bandgap voltage is a voltage across the resistor.

10. The circuit of claim 9, wherein the RC oscillator further comprises a second current summer having a first circuit branch to produce a PTAT current, a second circuit branch to produce a CTAT current, and a third circuit branch to produce a portion of the CTAT current, wherein a sum of the currents constitutes the bandgap current.

11. A circuit comprising:
a first voltage generator configured to generate a first voltage that varies with temperature;
a second voltage generator configured to generate a second voltage that varies with temperature in opposite relation to the first voltage;
a current generating circuit connected to the first current generator and the second voltage generator and having an output for a bandgap current based on the first voltage and the second voltage;
a voltage generating circuit connected to the first voltage generator and the second voltage generator and having an output for a bandgap voltage based on the first voltage and the second voltage;
a capacitor selectively configurable in a first configuration to receive the bandgap current to charge the capacitor and a second configuration to discharge the capacitor; and
a comparator configured to produce a comparator signal based on the bandgap voltage and a capacitor voltage across the capacitor, the capacitor being configured in the first configuration and the second configuration in response to the comparator signal, the comparator signal varying in time in response to the capacitor being charged and discharged, the comparator signal having a period that is based on the bandgap voltage across a resistor and the bandgap current.

12. The circuit of claim 11, wherein the current generating circuit comprises a circuit to sum the first voltage and the second voltage and apply a copy of a summed voltage across the resistor to generate a current, wherein the resistor varies with temperature and the bandgap voltage across the resistor varies with temperature with a same relation as the resistor;
the circuit further comprising: a frequency generator configured to produce an output signal using the comparator signal as a reference frequency; and
a calibration engine having an input to receive an external reference frequency and the comparator signal, the calibration engine configured to produce a multiplier based on the external reference frequency and a frequency of the comparator signal, the output signal having a frequency equal to the frequency of the comparator signal times the multiplier.

13. A method in an electronic circuit comprising:
generating a bandgap voltage;
generating a bandgap current; and
operating the electronic circuit using the bandgap voltage and the bandgap current.

14. The method of claim 13, further comprising generating the bandgap voltage and the bandgap current from a same core.

15. The method of claim 13, further comprising:
generating a first voltage that varies with temperature;
generating a second voltage that varies with temperature in opposite relation to the first voltage;
generating the bandgap current using a first combination of the first voltage and the second voltage; and
generating the bandgap voltage using a second combination of the first voltage and the second voltage.

16. The method of claim 15, wherein generating the bandgap current includes driving the first combination of the first voltage and the second voltage across a resistor in the electronic circuit.

17. The method of claim 15, wherein the first voltage is a complementary to absolute temperature (CTAT) voltage and the second voltage is a proportional to absolute temperature (PTAT) voltage.

18. The method of claim 13, further comprising:
generating a first current that varies with temperature;
generating a second current that varies with temperature in opposite relation to the first current;
generating the bandgap voltage using a first combination of the first current and the second current; and
generating the bandgap current using a second combination of the first current and the second current.

19. The method of claim 18, wherein generating the bandgap voltage includes driving the first combination of the first current and the second current across a resistor in the electronic circuit.

20. The method of claim 18, wherein the first current is a complementary to absolute temperature (CTAT) current and the second current is a proportional to absolute temperature (PTAT) current.

21. The method of claim 18, further comprising generating a temperature invariant oscillatory signal including:
charging a capacitor with the bandgap current;
discharging the capacitor when a voltage across the capacitor equals the bandgap voltage; and
repeating the charging and discharging of the capacitor, the temperature invariant oscillatory signal arising from changes in the voltage of the capacitor during the charging and discharging.

22. The method of claim 21, wherein a period of the temperature invariant oscillatory signal is proportional to a ratio of the bandgap voltage to the bandgap current.

23. The method of claim 21, further comprising driving a resistor of the first circuitry with the first combination of the first current and the second current to generate the bandgap voltage.

24. The method of claim 21, further comprising calibrating a frequency of the temperature invariant oscillatory signal to a reference frequency.

25. The method of claim 24, wherein the calibrating includes generating a multiplier determined from the reference frequency and the frequency of the oscillatory signal, the method further comprising generating an output signal by multiplying the frequency of the oscillatory signal with the multiplier.

26. The method of claim 25, further comprising receiving a scale factor and producing the multiplier based at least in part on the scale factor.

27. The method of claim 25, wherein the multiplier comprises a ratio of the reference frequency to the frequency of the oscillatory signal.

28. The method of claim 21, further comprising generating an output signal of the electronic circuit having a frequency that is determined using a frequency of the temperature invariant oscillatory signal.

29. The method of claim 28, wherein generating the output signal includes multiplying the frequency of the temperature invariant oscillatory signal by an integer-valued multiplier.

30. The method of claim 28, wherein generating the output signal includes multiplying the frequency of the temperature invariant oscillatory signal by a fractional-valued multiplier.
